(19) United States
(12) Patent Application Publication
(10) Pub. No.: US 2020/0192239 A1
(43) Pub. Date: Jun. 18, 2020

(54) POWDER PASTING DEVICE, IMAGE FORMING APPARATUS, POWDER PASTING METHOD, AND IMAGE FORMING METHOD

(71) Applicant: KONICA MINOLTA, INC., Tokyo (JP)

(72) Inventor: Atsuto HIRAI, Ikoma-shi (JP)

(73) Assignee: KONICA MINOLTA, INC., Tokyo (JP)

(21) Appl. No.: 16/680,897

(22) Filed: Nov. 12, 2019

(30) Foreign Application Priority Data
Dec. 14, 2018 (JP) 2018-234374

(51) Int. Cl. G03G 15/08

(52) U.S. Cl. CPC G03G 15/0815

(57) ABSTRACT

Provided is a powder pasting device for pasting powder on an image pattern formed on one main surface of a recording medium, the powder pasting device includes: a powder holding member having a powder holding surface holding powder by sticking; a powder supplying member that supplies powder to the powder holding surface; a rubbing member that rubs the powder holding surface to which powder has been supplied from the powder supplying member; and a facing member that is disposed at a position facing the powder holding surface of the powder holding member, sandwiches a recording medium having an image pattern functioning as an adhesive between the powder holding surface and the facing member, and thereby transfers the powder held on the powder holding surface by sticking onto the image pattern.

### BACKGROUND

The entire disclosure of Japanese patent Application No. 2018-234374, filed on Dec. 14, 2018, is incorporated herein by reference in its entirety.

### Technological Field

The present invention relates to a powder pasting device, an image forming apparatus, a powder pasting method, and an image forming method.

### Description of the Related art

As one of metallic printing techniques for forming a glossy image, a technique for attaching powder to a toner image is known. For example. JP 2013-178452 A discloses a technique for melting a printed toner image to impart stickiness thereto, and attaching coating powder to the sticky toner image. In this case, magnetic powder or charge powder to be charged by frictional charging is used as the coating powder, and the magnetic powder or the charge powder is adsorbed and, held on a powder holding means by magnetic force or electrostatic force. The coating powder adsorbed and held on the powder holding means is captured by the sticky toner image, and the coating powder is thereby selectively supplied to the toner image.

However, when the magnetic powder or the charge powder to be charged by frictional charging is used as the coating powder, the powder holding means for adsorbing and holding the magnetic powder or the charge powder by magnetic force or electrostatic force adsorbs and holds the coating powder in a plurality of layers. If the coating powder is non-spherical, the coating powder is adsorbed and held in various directions. For this reason, in a state where the coating powder is captured by the sticky toner image from the powder holding means, the number of layers of the coating powder and the direction thereof on a surface of the toner image are non-uniform, and an image to which the coating powder is attached cannot be sufficiently glossy.

### SUMMARY

Therefore, an object of the present invention is to provide a powder pasting device, an image forming apparatus, a powder pasting method, and an image forming method capable of obtaining a sufficiently glossy image.

To achieve the abovementioned object, according to an aspect of the present invention, there is provided a powder pasting device for pasting powder on an image pattern formed on one main surface of a recording medium, and the powder pasting device reflecting one aspect of the present invention comprises: a powder holding member having a powder holding surface holding powder by sticking; a powder supplying member that supplies powder to the powder holding surface, a rubbing member that rubs the powder holding surface to which powder has been supplied from the powder supplying member, and a facing member that is disposed at a position facing the powder holding surface of the powder holding member, sandwiches a recording medium having an image pattern functioning as an adhesive between the powder holding surface and the facing member, and thereby transfers the powder held on the powder holding surface by sticking onto the image pattern.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a configuration view of an image forming apparatus according to a first embodiment of the present invention;

FIG. 2 is a cross-sectional view for explaining an image formed by the image forming apparatus according to the first embodiment;

FIG. 3 is a configuration view illustrating a modification of the first embodiment;

FIG. 4 is a configuration view of an image forming apparatus according to a second embodiment of the present invention;

FIG. 5 is a configuration view of an image forming apparatus according to a third embodiment of the present invention; and

FIG. 6 is an observation image of a glossy image formed in Example.

### DETAILED DESCRIPTION OF EMBODIMENTS

Hereinafter, one or more embodiments of image forming apparatuses and image forming methods according to the present invention will be described with reference to the drawings. However, the scope of the invention is not limited, to the disclosed embodiments. Note that in each of the embodiments, the same constituent elements are denoted by the same reference numerals, and duplicate description is omitted.

### First Embodiment

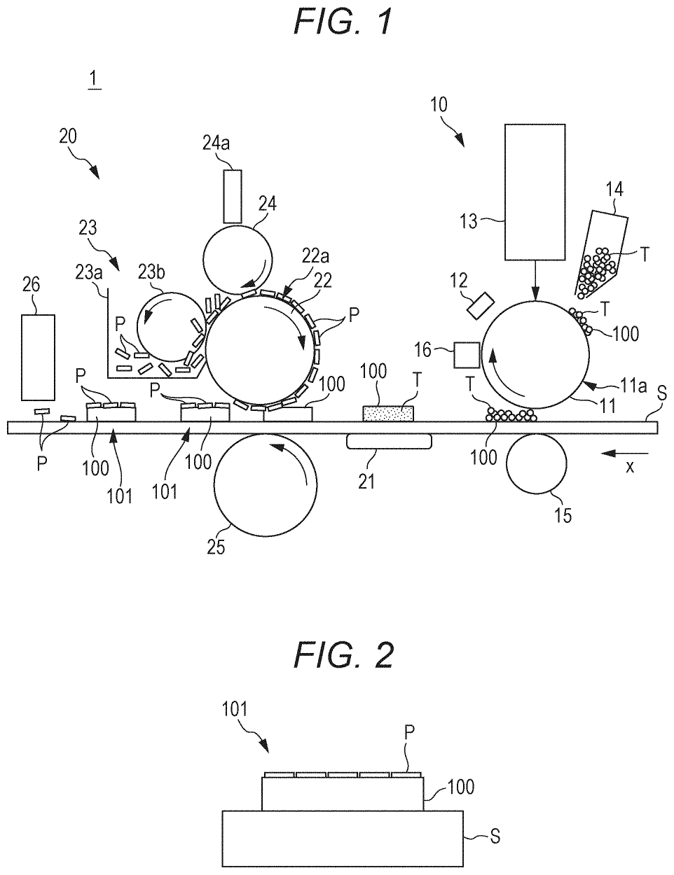

FIG. 1 is a configuration diagram of an image forming apparatus 1 according to a first embodiment of the present invention. The image forming apparatus I illustrated in this figure is for forming a glossy image, and includes a pattern forming device 10 and a powder pasting device 20. Among these apparatuses, the pattern forming device 10 is for forming an image pattern 100 formed of a material functioning as an adhesive as described below on a main surface of a recording medium S. Note that the recording medium S has a sheet shape, and may have an image formed on one main surface or both main surfaces by another image forming apparatus. The image may be a color image. The recording medium S may be one on which no image is formed.

The powder pasting device 20 is for forming a glossy image 101 in which, for example, glossy powder is pasted on the image pattern 100 formed in the pattern forming device 10. The pattern forming device 10 and the powder pasting device 20 have such configurations as follows.

<Pattern Forming Device 10>

The pattern forming device 10 only needs to be an image forming apparatus capable of forming the image pattern 100 formed of a material functioning as an adhesive on a main surface of the recording medium S. As the pattern forming device 10, a known image forming apparatus such as a dry or wet electrophotographic apparatus or an ink jet apparatus can be used.

Here, a case where a dry electrophotographic image forming apparatus is applied as the pattern forming device 10 will be described. As an example, the pattern forming device 10 includes a cylindrical photoreceptor 11, and a charging device 12, an optical writing device 13, a developing device 14, a transfer roller 15, and a cleaner 16 disposed around the photoreceptor 11. Hereinafter, the configuration of each of these members will be described, and then the configuration of a material functioning as an adhesive used here (hereinafter referred to as an adhesive material) will be described.

[Photoreceptor 11]

The photoreceptor 11 has a cylindrical shape and rotates around a cylindrical axis by a drive motor A cylindrical side peripheral surface is used as an image carrying surface 11a.

[Charging Device 12]

The charging device 12 is for charging the image carrying surface 11a of the photoreceptor 1 by corona discharge.

[Optical Writing Device 13]

The optical writing device 13 is a writing unit that forms an electrostatic latent image by irradiating the image carrying surface 11a of the charged photoreceptor 11 with a laser beam on the basis of image data, and is disposed on a downstream side of the charging device 12 in a rotation direction of the photoreceptor 11. The image data is data generated by an image reading unit (not illustrated) included in the image forming apparatus 1 or data received from an external device such as a personal computer connected, to the image forming apparatus 1 or another image forming apparatus.

[Developing Device 14]

The developing device 14 is for attaching a toner to an electrostatic latent image formed on the image carrying surface 11a by supplying a toner T that has been stirred and charged to the image carrying surface 11a of the photoreceptor 11, and is disposed on a downstream side of the optical writing device 13 in the rotation direction of the photoreceptor 11. Note that the toner used here is used as an adhesive material.

[Transfer Roller 15]

The transfer roller 15 is for transferring the toner T attached to the image carrying surface 11a of the photoreceptor 11 onto a main surface of the sheet-shaped recording medium S, and is disposed on a downstream side of the developing device 14 in the rotation direction of the photoreceptor 11. To the transfer roller 15, a voltage having the opposite polarity to that of the toner T is applied. The transfer roller 15 forms a nip portion that sandwiches the sheet-shaped recording medium S between the transfer roller 15 and the image carrying surface 11a of the photoreceptor 11. As a result, the toner T attached onto the image carrying surface 11a of the photoreceptor 11 is transferred onto a main surface of the recording medium S supplied to the nip portion between the image carrying surface 11a of the photoreceptor 11 and the transfer roller 15 toward the photoreceptor 11, and an image pattern 100 formed of the toner T is formed on the main surface of the recording medium S.

Note that the recording medium S which has passed through the nip portion between the image carrying surface 11a of the photoreceptor 11 and the transfer roller 15 and on which the image pattern 100 is formed is conveyed to the powder pasting device 20 by a conveyance mechanism (not illustrated).

[Cleaner 16]

The cleaner 16 is for removing the toner T remaining on the image carrying surface 11a of the photoreceptor 11, and is disposed on a downstream side of the transfer roller 15 and on an upstream side of the charging device 12 in the rotation direction of the photoreceptor 11. As a result, an image carrying surface 21a to which the toner T is not attached is supplied to the charging device 12.

[Adhesive Material (Toner T)]

An adhesive material in the present embodiment is the toner T supplied from the developing device 14, and is a material that is melted by being heated to a predetermined temperature to exhibit stickiness, and is cured by heat dissipation after being melted to exhibit adhesiveness. Note that the adhesive material may be cured more firmly by cooling or light irradiation The adhesive material may be either a colored toner or a transparent toner, and is appropriately selected depending on the color tone of an image formed by the image forming apparatus 1.

If the pattern forming device 10 is a wet electrophotographic image forming apparatus or an ink jet apparatus, liquid ink is used instead of the toner T as the adhesive material.

<Powder Pasting Device 20>

The powder pasting device 20 is for forming the glossy image 101 by pasting the glossy powder P, for example, decorative powder on the image pattern 100 formed on a main surface of the recording medium S, and is disposed on a downstream side of the pattern forming device 10 and in the latter stage with respect to a conveyance direction x of the recording medium S. As an example, the powder pasting device 20 includes a heating member 21 and a cylindrical powder holding member 22, and a powder supplying member 23, a rubbing member 24, and a facing member 25 disposed around the powder holding member 22, and further includes a powder collecting member 26. Hereinafter, the configuration of each of these members will be described, and then the configuration of the glossy powder P used here will be described.

[Heating Member 21]

The heating member 21 is for melting the image pattern 100 formed on a main surface of the recording medium S by heating in the pattern forming device 10, and is disposed on a conveyance path of the recording medium S on which the image pattern 100 is formed in the pattern forming device 10. The image pattern 100 heated by the heating member 21 is melted to exhibit stickiness, and then is cured to exhibit adhesiveness. Note that a pressure member (not illustrated) may be disposed at a position sandwiching the conveyance path of the recording medium S between the pressure member and the heating member 21, and the recording medium S and the image pattern 100 sandwiched between the heating member 21 and the pressure member may be heated and pressurized. With such a configuration, a surface of the image pattern 100 can be smoothed. It is only required to melt the image pattern 100 at the heating temperature of the image pattern 100 by the heating member 21. For example, the heating temperature is 60° C. to 130° C.

Note that the heating member 21 only needs to be disposed as necessary. When the image pattern 100 formed in the pattern forming device 10 has stickiness without being melted by heating, the heating member 21 does not need to be disposed. However, in this case, a heating unit or a light irradiation unit is disposed for exhibiting adhesiveness by curing the image pattern 100 after the powder P is transferred onto the image pattern 100 by passing through the facing member 25 described below.

[Powder Holding Member 22]

The powder holding member 22 has a cylindrical shape and rotates around a cylindrical axis by a drive motor. A cylindrical side peripheral surface is used as a powder holding surface 22a. The powder holding surface 22a of the powder holding member 22 has stickiness, and holds the powder P described next by sticking.

The powder holding surface 22a preferably has adhesive force (also referred to as cohesive force) of 28 kPa or more. This makes it possible to hold the powder P well as described in the following Example. An upper limit of the adhesive force of the powder holding surface 22a is within a range in which powder is transferred from the powder holding surface 22a onto the image pattern 100 when the image pattern 100 described below exhibits adhesive force. Therefore, the upper limit of the adhesive force of the powder holding surface 22a is 470 kPa or less, and preferably 350 kPa or less. This makes it possible to transfer powder from the powder holding surface 22a onto the image pattern 100. Examples of a material constituting the powder holding surface 22a include fluororubber, silicon rubber, and urethane rubber. However, the material is not limited to these rubber materials and may be another resin materials or a metal material as long as having adhesive force capable of holding powder

The powder holding member 22 is disposed on a downstream side of the heating member 21 on the conveyance path of the recording medium S and on a main surface where the image pattern 100 is formed on the recording medium S. The powder holding member 22 rotates in a direction along the conveyance direction x of the recording medium S on a side toward the recording medium S. Note that when the image pattern 100 is heated by the heating member 21 to exhibit stickiness, heat is also transmitted to the powder holding member 22. Therefore, a material constituting the powder holding member 22, particularly a material constituting the powder holding surface 22a preferably has heat resistance. As such a material, silicon rubber is preferably used among the rubber materials described above.

[Powder Supplying Member 23 ]

The powder supplying member 23 is for supplying the powder P to the powder holding surface 22a of the powder holding member 22, and is disposed in an axial direction of the cylindrical powder holding member 22. The powder supplying member 23 includes a storage container 23a for storing the powder P and a conveying member 23b housed in the storage container 23a.

Among these, the storage container 23a has an opening formed in an axial direction of the powder holding surface 22a of the cylindrical powder holding member 22.

The conveying member 23b is, for example, a rotating cylindrical brush or sponge, or has a screw shape. The conveying member 23b rotates in the opposite direction to the powder holding member 22, thereby conveys the powder P stored in the storage container 23a to the opening of the storage container 23a, and supplies the powder P to the powder holding surface 22a of the powder holding member 22.

Note that the powder supplying member 23 is not limited to such a configuration, and for example, may directly bring the powder holding surface 22a of the powder holding member 22 into contact with the powder P stored in the storage container 23a.

[Rubbing Member 24 ]

The rubbing member 24 is for orienting the powder P on the powder holding surface 22a of the powder holding member 22 by rubbing the powder holding surface 22a of the powder holding member 22, and is disposed on a downstream side of the powder supplying member 23 in the rotation direction of the powder holding member 22. The rubbing member 24 includes a powder collecting member 24a.

The rubbing member 24 has a cylindrical shape and is disposed in contact with the powder holding surface 22a to rub the powder holding surface 22a of the rotating powder holding member 22. A side peripheral surface of the rubbing member 24 that nibs the powder holding surface 22a is preferably formed of a material having voids for housing the powder P. As such a material, for example, a brush or a porous material such as a sponge or a nonwoven fabric is used.

The rubbing member 24 rubs the powder holding surface 22a of the rotating powder holding member 22 to remove excess powder P not stuck on the powder holding surface 22a out of the powder P supplied to the sticky powder holding surface 22a. At this time, the excess powder P is captured in the, voids on the side peripheral surface of the rubbing member 24.

As a result, one layer of the powder P is left in a state of being directly stuck to the sticky powder holding surface 22a. At this time, as described in detail later, if the powder P is non-spherical, the powder P is rubbed by the rubbing member 24 on the powder holding surface 22a, and directionality of the powder P with respect to the powder holding surface 22a can be thereby aligned.

The rubbing member 24 preferably rotates around, a cylindrical axis. As a result, the powder P captured and housed in the voids can be continuously conveyed in the rotation direction. Therefore, the powder P does not accumulate in the nip portion between the powder holding surface 22a and the rubbing member 24, and an effect of removing the excess powder P from the powder holding surface 22a is enhanced. This also makes it possible to stabilize a rubbing property of the powder holding surface 22a by the rubbing member 24.

Furthermore, if the rotation direction of the rubbing member 24 is the same as the rotation direction of the powder holding member 22, a relative speed of the rubbing member 24 with respect to the powder holding member 22 is further increased, the powder holding surface 22a of the powder holding member 22 can be rubbed by the rubbing member 24 at a higher speed, and a higher rubbing effect can be obtained.

Pressing force [N] of the rubbing member 24 against the powder holding surface 22a of the powder holding member 22 is preferably 1 to 10 kPa, and more preferably 1 to 5 kPa. If the pressing force [N] is too low, pressing of the powder holding member 22 in an axial direction is unstable. Meanwhile, if the pressing force [N] is too high, a torque for rotating the rubbing member 24 increases, causing drive unevenness of the rubbing member 24 or material deterioration of the rubbing member 24 and the powder holding member 22.

The powder collecting member 24a disposed in the rubbing member 24 is disposed so as to face a side peripheral surface of the rubbing member 24, and collects the powder P stored in the voids on the side peripheral surface of the rubbing member 24. The powder collecting member 24a may be an air suction type member or a member that brings a roller or a blade-shaped member into contact with the side peripheral surface of the rubbing member 24 and ejects the powder P from the voids by a restoring force of a material constituting the side peripheral surface of the rubbing member 24.

By disposing the powder collecting member 24a in the rubbing member 24, it is possible to maintain an effect of removing the powder P by the rubbing member 24, and to maintain a rubbing property of the powder holding surface 22a by the rubbing member 24 for a long time. Note that the rubbing member 24 as described above may also serve as the conveying member 23b in the powder supplying member 23.

[Facing Member 25]

The facing member 25 is for transferring the powder P stuck and held on the powder holding surface 22a of the powder holding member 22 onto the image pattern 100 formed on a main surface of the recording medium S. The facing member 25 has a roller shape, and constitutes a nip portion that sandwiches the recording medium S between the facing member 25 and the powder holding member 22. As a result, the powder P stuck and held on the powder holding surface 22a of the powder holding member 22 in a state of being oriented is brought into contact with and pressed against the image pattern 100 melted by heating with the heating member 21 and exhibiting stickiness, and the powder P in a state of being oriented is transferred from the powder holding surface 22a onto the image pattern 100. In addition, the image pattern 100 is in a stage where the image pattern 100 is cured by fall of temperature after passing through the heating member 21. Therefore, adhesiveness is exhibited by cluing, and the powder P is bonded and held onto the image pattern 100. As a result, the glossy image 101 in which the glossy powder P is pasted on a surface of the image pattern 100 constituted by the toner T serving as an adhesive material can be obtained.

[Powder Collecting Member 26]

The powder collecting member 26 is for collecting the excess powder P on the recording medium S that has passed through the nip portion between the powder holding member 22 and the facing member 25. The powder collecting member 26 is disposed on a downstream side of the nip portion between the powder holding member 22 and the facing member 25 on the conveyance path of the recording medium S, and on a side where the image pattern 100 is formed on the recording medium S. Here, the excess powder P on the recording medium S is the powder P that is not bonded and held onto the image pattern 100.

Examples of the powder collecting member 26 include a member that sucks the powder P by air suction, but the powder collecting member 26 is not limited thereto.

[Glossy Powder P]

Next, the configuration of the glossy powder P used in the powder pasting device 20 as described above will be described. The powder P has a non-spherical shape that is not a true sphere. The powder P is preferably flat from a viewpoint of orientation along the powder holding surface 22a. Here, the flat powder P means that the powder P has a shape in which a ratio of a minor axis [W] to a thickness [t] is 3 or more when a maximum length of the powder P is represented by a major axis [L], a maximum length of the powder P in a direction orthogonal to the major axis [L] is represented by the minor axis [W], and a minimum length of the powder P in a direction orthogonal to the major axis [L] and the minor axis [W] is represented by the thickness [t]. As a result, the flat powder P is rubbed by the rubbing member 24 on the powder holding surface 22a, and a wide surface including the major axis [L] direction and the minor axis [W] direction is thereby stuck on the powder holding surface 22a. The flat powder P is held on the powder holding surface 22a in a state of being oriented.

The thickness [t] of the flat powder P is preferably about 0.2 to 10 μm, and more preferably 0.2 to 5.0 μm from a viewpoint of sufficiently exhibiting glossiness due to the powder P when the powder P is bonded to the image pattern 100 in an oriented state.

When the thickness [t] is too small, it is difficult to collect the powder P that is not stuck on the powder holding surface 22a but is superimposed on other particles of the powder P. In this case, the flat powder P cannot be sufficiently oriented in a state where the surface including the major axis [L] direction of the flat powder P and the minor axis [W] direction thereof is stuck on the sticky powder holding surface 22a, and it is difficult to directly stick one layer of the powder P on the powder holding surface 22a. In addition, the powder P is easily broken during a process, and variation is likely to occur in the sizes of particles of the powder P. Meanwhile, when the thickness [t] is too large, the powder P bonded to the image pattern 100 is easily detached from the image pattern 100.

The major axis [L] of the flat powder P and the minor axis [W] thereof are each preferably about 1 to 50 μm, and more preferably 15 to 50 μm. When the major axis [L] and the minor axis [W] are too small, handling is difficult. Meanwhile, when the major axis [L] and the minor axis [W] are too large, it is difficult to form an image with high resolution. This causes a reduction in gradation of the image.

A material of the powder P is not limited as long as being able to obtain desired gloss. The material may be insulating or conductive, and may be magnetic or non-magnetic. The powder P preferably includes a metal or a metal oxide from a viewpoint of exhibiting desired gloss, and can include particles of two or more types of materials.

Examples of the powder P include powder formed of a metal material, powder formed of a metal oxide, metal powder having a surface coated with a metal oxide layer or a resin layer, metal oxide powder having a surface coated with a metal layer or a resin layer, and resin powder having a surface coated with a metal layer or a metal oxide layer.

The powder P as described above may be a synthetic product or a commercial product. Examples of the commercial product used as the powder P include Sunshine Baby Chrome Powder, Aurora Powder, and Pearl Powder (these are manufactured by GG Corporation), ICEGEL Mirror Metal Powder (manufactured by TAT Co., Ltd). Pika-ace MC Shine Dust, Effect. C (manufactured by Kurachi Co. Ltd., “Pika-ace” is registered trademark of Kurachi Co., Ltd.), PREGEL Magic Powder, Mirror Series (manufactured by PREANFA Ltd., “PREGEL is registered trademark of PREANFA Ltd.), Borman Shine Powder (manufactured by K's Planning Co., Ltd., “BONNAIL” is registered trademark of K's Planning Co., Ltd.), Metashine (manufactured by Nippon Sheet Glass Co., Ltd., Metashine is registered trademark of Nippon Sheet Glass Co., Ltd.), LG neo (manufactured by OIKE Co., Ltd., LG neo is registered trademark of OIKE Co., Ltd.), Astroflake (manufactured by Nihoriboshitsu Co., Ltd., registered trademark of Hajime Okazaki), and aluminum pigment (manufactured by Toyo Aluminum Co., Ltd.).

<Image Forming Method>

Next, an image forming method according to the first embodiment will be described. The image forming method described here is an image forming method performed by the image forming apparatus 1 described with reference to FIG. 1, and is performed as follows. First, in the pattern forming device 10 of the image forming apparatus 1, the image pattern 100 constituted by the toner T functioning as an adhesive is formed on one main surface of the recording medium S.

Subsequently, the recording medium S on which the image pattern 100 is formed is conveyed to the powder pasting device 20, and the image pattern 100 formed on the recording medium S is heated to a predetermined temperature by the heating member 21 of the powder pasting device 20 to be melted.

Meanwhile, to the powder holding surface 22a of the powder holding member 22 in the powder pasting device 20, the glossy powder P is supplied. Furthermore, the powder holding surface 22a is rubbed by the rubbing member 24, and the powder P is thereby stuck and held on the powder holding surface 22a in a state of being oriented in a single layer. In this state, the recording medium S that has passed through the heating member 21 is conveyed to the nip portion between the powder holding member 22 of the powder pasting device 20 and the facing member 25. As a result, while the powder P that is stuck and held on the powder holding surface 22a of the powder holding member 22 holds the sticky state on the powder holding surface 22a, that is, while the powder P is oriented in a single layer, the powder P is transferred onto the image pattern 100 exhibiting stickiness by melting.

Thereafter, the powder P that has been transferred onto the image pattern 100 is bonded to the image pattern 100 by curing the image pattern 100 by heat dissipation. As a result, the glossy image 101 in which the glossy powder P is pasted on the image pattern 100 formed of the toner T is obtained.

FIG. 2 is a cross-sectional view for explaining an image formed by the image forming apparatus according to the first embodiment. As illustrated in this figure, the glossy image 101 formed on the recording medium S by this image forming apparatus has the glossy powder P pasted on a surface of the image pattern 100 functioning as an adhesive in a state where the powder P is oriented in a single layer.

### Effect of First Embodiment

According to the image forming apparatus 1 and the image forming method described above, the glossy powder P is pasted on a surface of the image pattern 100 functioning as an adhesive in a state of being oriented in a single layer. As a result, the glossy image 101 having sufficient glossiness can be obtained. In addition, since the powder P is directly pasted on the image pattern 100 in a state of being oriented in a single layer, attachment force between the image pattern 100 and each particle of the powder P is high, and the powder P is not detached from the image pattern 100. For this reason, the glossiness of the glossy image 101 can be stably maintained over a long period of time. Furthermore, it is possible to prevent attachment of the powder P to a region other than the image pattern 100 in a step of pasting the powder P.

### Modification of First Embodiment

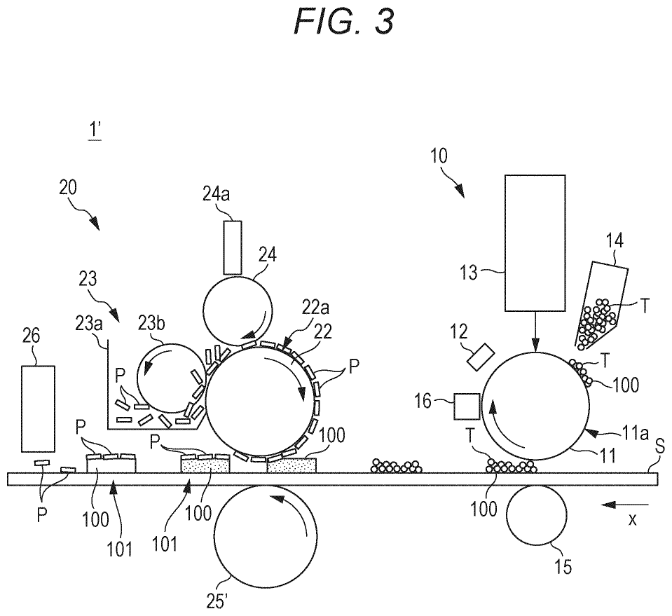

FIG. 3 is a configuration view illustrating a modification of the first embodiment. An image forming apparatus 1′ illustrated in this figure does not include a special heating member, and a facing member 25′ forming a nip portion between the powder holding member 22 and the facing member 25′ also serves as a heating member. In the image forming apparatus 1′ having such a configuration, when the image pattern 100 is heated by the facing member 25′ to exhibit stickiness, heat is also easily transmitted to the powder holding member 22. For this reason, a material constituting the powder holding member 22, particularly a material constituting the powder holding surface 22a preferably has heat resistance like the silicon rubber described above.

Even with the configuration of such a modification, it is possible to exhibit similar effects to the effects exhibited by the image forming apparatus according to the first embodiment. Note that this modification can be similarly applied to the following embodiments.

### Second Embodiment

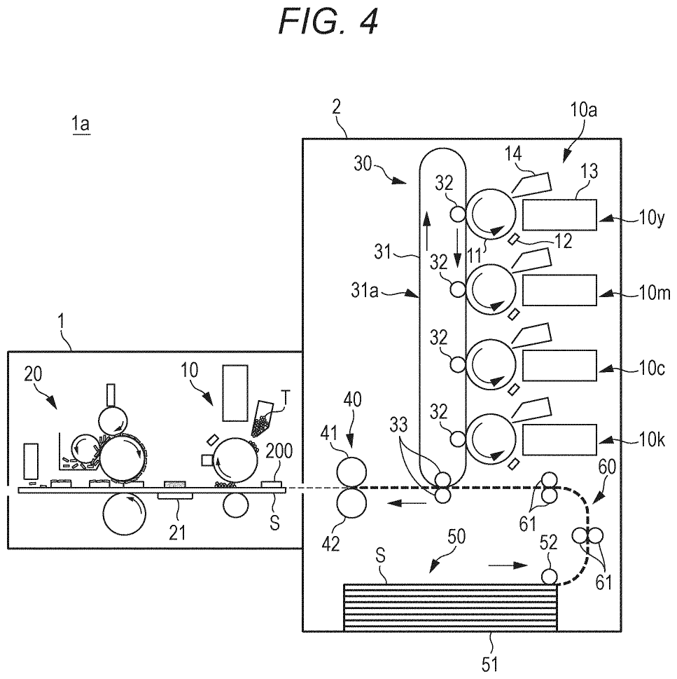

FIG. 4 is a configuration view of an image forming apparatus 1a according to a second embodiment of the present invention. In the image forming apparatus 1a according to the second embodiment illustrated in this figure, the image, forming apparatus 1 for glossy image formation described in the first embodiment is connected to the latter stage of a dry electrophotographic color image forming apparatus 2. Therefore, only the configuration of the color image forming apparatus 2 will be described below.

<Color Image Forming Apparatus 2>

The color image forming apparatus 2 is disposed in the former stage of the image forming apparatus 1 for glossy image, and may be a normal image forming apparatus. A known image forming apparatus such as a dry or wet electrophotographic image forming apparatus or an inkjet image forming apparatus can be used. However, here, a dry electrophotographic image forming apparatus is used. The color image forming apparatus 2 includes a color image forming unit 10a, a transfer unit 30, a fixing unit 40, a paper supplying unit 50, and a paper conveying unit 60, and these each have such a configuration as follows.

[Color Image Forming Unit 10a]

The color image forming unit 10a includes, for example, four pattern forming units 10y, 10m, 10c, and 10k for forming colored toner patterns of yellow (Y), magenta (M), cyan (C), and black (K). Each of the pattern forming units 10y, 10m, 10c, and 10k includes a photoreceptor 11, a charging device 12, an optical writing device 13, and a developing device 14. These devices may be similar to those of the pattern forming device 10 described above.

However, toners supplied from the developing devices 14 of the pattern forming units 10y, 10m, 10c, and 10k are colored toners of the respective colors. These colored toners have a higher melting temperature than the toner T serving as an adhesive used in the image forming apparatus 1, and are not melted by heating in the heating member 21 included in the powder pasting device 20. Note that when the glossy powder P is to be pasted also on the colored image pattern 200 formed of a colored toner in the image forming apparatus 1, the melting temperature of the colored toner may be about the same as the melting temperature of the toner T used in the image forming apparatus 1.

[Transfer Unit 30]

The transfer unit 30 is disposed in parallel with the color image forming unit 10a. The transfer unit 30 includes an intermediate transfer belt 31, a primary transfer roller 32, and a pair of secondary transfer rollers 33.

Among these, the intermediate transfer belt 31 is configured as a rotating endless belt, and an outer peripheral surface thereof is an image carrying surface 31a. The intermediate transfer belt 31 rotates in the opposite direction to rotation of each of the photoreceptors 11, and is disposed in a state where the image carrying surface 31a is sequentially brought into contact with all of the photoreceptors 11.

To the primary transfer roller 32, a voltage having the opposite polarity to that of the toner is applied, and the primary transfer roller 32 is disposed in a state where the intermediate transfer belt 31 is sandwiched between the primary transfer roller 32 and each of the photoreceptors 11. As a result, the colored toner attached onto the image carrying surface 21a of the photoreceptor 11 is transferred onto the image carrying surface 31a of the intermediate transfer belt 31, and a colored image pattern 200 in which the toner images of the respective colors are superimposed on the image carrying surface 31a of the intermediate transfer belt 31 is formed.

The pair of secondary transfer rollers 33 is disposed in a state of sandwiching the intermediate transfer belt 31 therebetween and transfers the colored image pattern 200 formed on the image carrying surface 31a of the intermediate transfer belt 31 onto the sheet-shaped recording medium S conveyed from the paper supplying unit 50 described below.

[Fixing Unit 40]

The fixing unit 40 includes a heating unit 41 and a pressure bonding roller 42 disposed so as to face the heating unit 41. The fixing unit 40 nips the recording medium S conveyed from the secondary transfer roller 33 and fixes the color image transferred onto the recording medium S to the recording medium S.

[Paper Supplying Unit 50]

The paper supplying unit 50 includes a cassette 51 that stores the recording medium S and a feeding roller 52 that feeds the recording medium S stored in the cassette 51 one by one from the cassette 51, and supplies the recording medium S from the cassette 51 to the paper conveying unit 60.

[Paper Conveying Unit 60]

The paper conveying unit 60 conveys the recording medium S supplied from the paper supplying unit 50 along a predetermined route, and includes a plurality of roller pairs 61. The paper conveying unit 60 conveys the recording medium S supplied from the paper supplying unit 50 to the secondary transfer roller 33 and the fixing unit 40, and further conveys the recording medium S to the pattern forming device 10.

<Image Forming Method>

In the image forming method performed by the image forming apparatus 1a as described above, first, the color image forming apparatus 2 forms the colored image pattern 200 on one main surface of the recording medium S. Subsequently, the recording medium S on which the colored image pattern 200 is formed is supplied to the pattern forming device 10 of the image forming apparatus 1. Thereafter, the glossy image 101 is formed in a similar procedure to the image forming method according to the first embodiment.

### Effect of Second Embodiment

With the image forming apparatus 1a and the image forming method according to the second embodiment described above, it is possible to form the glossy image 101 having sufficient glossiness and stably maintaining sufficient glossiness over a long period of time on the recording medium S on which the colored image pattern 200 is formed.

Note that in the image forming method described in the second embodiment, when the glossy powder P only needs to be pasted only on the colored image pattern 200 formed of a colored toner, it is only required to make the color image forming apparatus 2 function as a pattern forming device. In this case, the image forming apparatus 1a may omit the pattern forming device 10. By using the colored toners used in the pattern forming units 10y, 10m, 10c, and 10k of the color image forming apparatus 2 as the toner T serving as the adhesive material described above, the color image pattern that functions as an adhesive only needs to be formed by the color image forming apparatus 2. With such a configuration, it is also possible to obtain a glossy color image.

### Third Embodiment

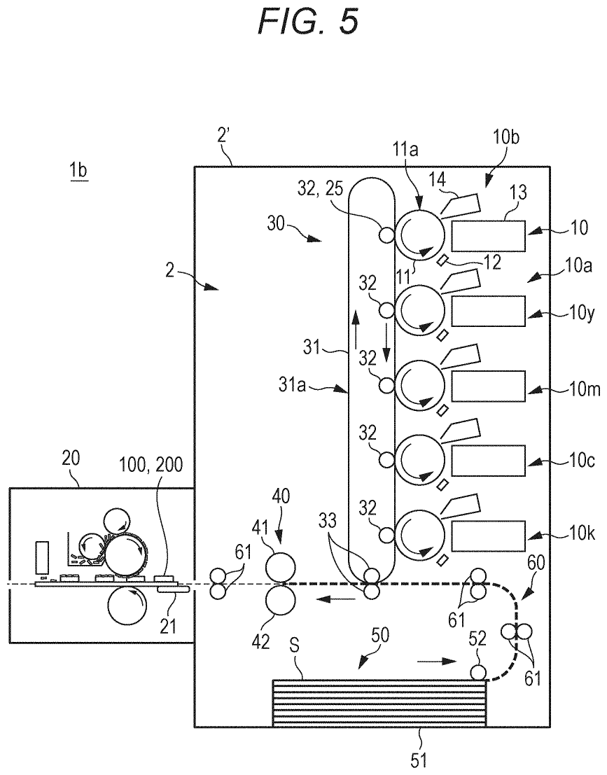

FIG. 5 is a configuration view of an image forming apparatus 1b according to a third embodiment of the present invention. In the image forming apparatus 1b according to the third embodiment illustrated in this figure, a part of the image forming apparatus 1 for glossy image formation described in the first embodiment is incorporated in an electrophotographic color image forming apparatus 2′, and the image forming apparatus 1b has such a configuration as follows.

<Color Image Forming Apparatus 2′>

The color image forming apparatus 2′ is obtained by combining the color image forming apparatus 2 described in the second embodiment with the pattern forming device 10 described in the first embodiment. The pattern forming device 10 is for forming an image pattern 100 formed of a material functioning as an adhesive, and is disposed in parallel with four pattern forming units 10y, 10m, 10c, and 10k for forming a colored toner pattern. The pattern forming device 10 forms the image pattern 100 on an intermediate transfer belt 31.

In the color image forming apparatus 2′, the four pattern forming units 10y, 10m, 10c, and 10k for forming a colored toner pattern form a colored image pattern 200 in which toner images of the respective colors are superimposed on an image carrying surface 31a of the intermediate transfer belt 31, and the pattern forming device 10 further forms the image pattern 100 formed of a toner T serving as an adhesive material on the image carrying surface 31a of the intermediate transfer belt 31.

Similarly to the first embodiment, the colored toners used in the four pattern forming units 10y, 10m, 10c, and 10k each have a higher melting temperature than the toner T serving as an adhesive material used in the pattern forming device 10. That is, the colored toners used in the pattern forming units 10y, 10m, 10c, and 10k are not melted by heating in a heating member 21 included in a powder pasting device 20.

<Powder Pasting Device 20>

The powder pasting device 20 is disposed in the latter stage of the color image forming apparatus 2′, and the recording medium S on which the colored image pattern 200 and the image pattern 100 are formed by the color image forming apparatus 2′ is conveyed to the powder pasting device 20. The configuration of the powder pasting device 20 is similar to that described in the first embodiment.

Note that when the image pattern 100 is melted by heating at a fixing unit 40 of the color image forming apparatus 2′ and exhibits stickiness, and the stickiness is maintained to a powder holding member 22 of the powder pasting device 20, the heating member 21 does not need to be disposed in the powder pasting device 20.

<Image Forming Method>

In the image forming method performed by the image forming apparatus 1b as described above, first, the color image forming apparatus 2′ forms the colored image pattern 200 on one main surface of the recording medium S and the image pattern 100 formed of the toner T serving as an adhesive material. Subsequently, the recording medium S on which the colored image pattern 200 and the image pattern 100 are formed is supplied to the powder pasting device 20. Thereafter, a glossy image 101 is formed in a similar procedure to the image, forming method according to the first embodiment.

### Effect of Third Embodiment

With the image forming apparatus 1b and the image forming method according to the third embodiment described above, it is possible to form the colored image pattern 200 and the glossy image 101 having sufficient glossiness and stably maintaining sufficient glossiness over a long period of time on the recording medium S.

Note that as described in the second embodiment, when the glossy powder P only needs to be pasted only on a colored image pattern formed of a colored toner, the image forming apparatus 1b may omit the pattern forming device 10. By using the colored toners used in the pattern forming units 10y, 10m, 10c, and 10k of the color image forming apparatus 2 as the toner T serving as the adhesive material described above, the color image pattern functioning as an adhesive only needs to be formed by the color image forming apparatus 2. With such a configuration, it is also possible to obtain a glossy color image.

The powder pasting device 20 may be separate from the color image forming apparatus 2′, or may be attached to the color image forming apparatus 2′ afterwards. In this case, if a toner functioning as an adhesive can be used as a colored toner, it is also possible to obtain a glossy color image by attaching the powder pasting device 20 to a normal color image forming apparatus.

### EXAMPLE

Next, description will be given of experimental results of examining adhesive force of a powder holding surface of a powder holding member in the image forming apparatus according to an embodiment of the present invention.

<Measurement of Adhesive Force of Powder Holding Member 22>

First, a result of measuring adhesive force of each material constituting a powder holding surface of a powder holding member will be described. Adhesive force was measured by using a tacking tester FSR-1000 (manufactured by RHESCA Co., LTD.: trade name) and by regarding force required for pressing a tip of a probe against a sample surface and peeling the tip off as adhesive force. Measurement conditions are as follows.

(1) Probe diameter: Diameter 10 mm

(2) Pressing speed: 5 mm/sec

(3) Pressing pressure: 50 kPa

(4) Pressing holding time: 1 second

(5) Probe lifting speed: 5 mm/sec

(6) Measurement temperature: 20° C.

The following Table 1 illustrates measurement results. Note that adhesive force is expressed in terms of pressure based on the area of the tip of the probe.

TABLE 1

| | | Rubber | Hardness | Adhesive |
|---|---|---|---|---|
| | | thickness | (JISA) | force |
| Type | Product No. | (mm) | (°) | (kPa) |
| EPDM | EB270N | 2 | 68 | 8 |
| NBR | RBTM | 2 | 53 | 9 |
| Fluororubber | RBFM | 2 | 75 | 28 |
| Silicon | RBAM | 2 | 53 | 82 |
| rubber | | | | |
| Urethane | UTM | 2 | 77 | 150 |
| rubber | | | | |

Values of adhesive force are values under pressing force of 50 kPa

<Formation of Glossy Image>

Next, a glossy image was formed using a powder holding member having adhesive force measured as described above, and gloss unevenness of the formed glossy image was observed. Here, the image formation of Experiments No. 1 to No. 15 in which the combination of a powder holding member, a rubbing member, and powder was changed was performed as follows, and gloss unevenness in each of the formed glossy images was observed.

[Formation of Image Pattern]

An image pattern formed of a black toner was formed using an electrophotographic image forming apparatus (AccurioPress C2060: manufactured by Konica Minolta, Inc.).

[Orientation of Powder by Rubbing]

Powder was supplied onto a powder holding surface of each powder holding member fixed on a flat plate, and a rubbing member was moved in parallel with the powder holding surface in a state of being in contact with the powder holding surface to rub the powder holding surface. Rubbing conditions are as follows.

(1) Rubbing member: wiping cloth (foray see: manufactured by Foray Industries, Inc.), sponge (styrene butadiene (SBR) sponge: Ramuse Makeup Sponge)

(2) Powder: LG NEO #325 (manufactured by HORI METAL LEAF & POWDER CO., LTD.: metal material surface is coated with resin: insulating), Metashine ME2025PS (manufactured by Nippon Sheet Glass Co., Ltd.: glass substrate surface is coated with silver: conductive)

(3) Pressing force during rubbing [N]: 5 kPa

(4) Rubbing distance: 1 cm

(5) Rubbing speed: 200 mm/sec

(6) Rubbing frequency: 5 times

[Pasting Powder]

A recording medium was placed on a hot plate heated to 120° C. with the image pattern formed of the black toner facing upward, and rubbing was performed under the above conditions. A powder holding member having a thin layer of powder was thereby brought into contact with and pressed against the image pattern. As a result, the powder was transferred only onto the image pattern formed of the black toner to form a glossy image.

[Observation of Gloss Unevenness]

Using a digital microscope VHX-6000 (manufactured by Keyence Corporation), observation was performed at a magnification of 100 times, and it was determined whether gloss unevenness was observed or not in the glossy image formed. The results are illustrated in Table 2 below together with the combination of the powder holding member, the rubbing member, and the powder.

TABLE 2

| | Powder holding member | | | | |
|---|---|---|---|---|---|
| | | Adhesive | | | |
| | | force | Type of rubbing | | |
| Experiment No. | Type | (kPa) | member | Type of powder | Gloss unevenness |
| No. 1 | EPDM | 8 | Sponge | LG neo | Observed |
| No. 2 | NBR | 9 | Sponge | LG neo | Observed |
| No. 3 | Fluororubber | 28 | Sponge | LG neo | Not observed |
| No. 4 | Silicon rubber | 82 | Sponge | LG neo | Not observed |
| No. 5 | Urethane rubber | 150 | Sponge | LG neo | Not observed |
| No. 6 | EPDM | 8 | Wiping cloth | LG neo | Observed |
| No. 7 | NBR | 9 | Wiping cloth | LG neo | Observed |
| No. 8 | Fluororubber | 28 | Wiping cloth | LG neo | Not observed |
| No. 9 | Silicon rubber | 82 | Wiping cloth | LG neo | Not observed |
| No. 10 | Urethane rubber | 150 | Wiping cloth | LG neo | Not observed |
| No. 11 | EPDM | 8 | Sponge | Metashine | Observed |
| No. 12 | NBR | 9 | Sponge | Metashine | Observed |
| No. 13 | Fluororubber | 28 | Sponge | Metashine | Not observed |
| No. 14 | Silicon rubber | 82 | Sponge | Metashine | Not observed |
| No. 15 | Urethane rubber | 150 | Sponge | Metashine | Not observed |

Values of adhesive force are values under pressing force of 50 kPa

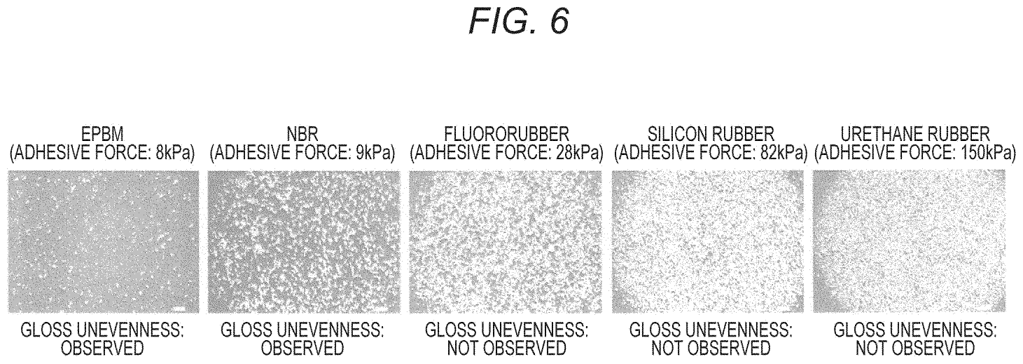

FIG. 6 illustrates observation images of the glossy images formed in Example, and are images obtained by photographing the glossy images formed in Experiments No. 1 to No. 5 at a magnification of 100 times.

As illustrated in the above results of Table 2 and FIG. 6, it has been confirmed that if adhesive force of a powder holding surface in a powder holding member is 28 kPa or more, glossy powder is well bonded to and held on a surface of an image pattern, and a glossy image having sufficient glossiness and no gloss unevenness is formed. In addition, as a result of observing these images, it has been confirmed that the powder is pasted in a state of being oriented in a single layer in an image having no gloss unevenness.

In addition, from this result, it has been confirmed that if a powder holding surface in a powder holding member has adhesive force of 28 kPa or more, by rubbing the powder holding surface with a rubbing member, even when an excess of powder supplied to the powder holding surface is removed, powder directly stuck on the powder holding surface can be continuously held. Furthermore, it has been confirmed that the powder directly stuck on the powder holding surface is stuck and held on the powder holding surface in a well-oriented state, and the powder stuck and held in such a manner can he transferred onto an image pattern.

Although embodiments of the present invention have been described and illustrated in detail, the disclosed embodiments are made for purposes of illustration and example only and not limitation. The scope of the present invention should he interpreted by terms of the appended claims.

What is claimed is:

1. A powder pasting device for pasting powder on an image pattern formed on one main surface of a recording medium, the powder pasting device comprising:
a powder holding member having a powder holding surface holding powder by sticking;
a powder supplying member that supplies powder to the powder holding surface;
a rubbing member that nibs the powder holding surface to which powder has been supplied from the powder supplying member; and
a facing member that is disposed at a position facing the powder holding surface of the powder holding member, sandwiches a recording medium having an image pattern functioning as an adhesive between the powder holding surface and the facing member, and thereby transfers the powder held on the powder holding surface by sticking onto the image pattern.

2. The powder pasting device according to claim 1, wherein
the powder is non-spherical.

3. The powder pasting device according to claim 1, wherein
the powder is flat.

4. The powder pasting device according to claim 1, wherein
the powder holding surface has adhesive force of 28 kPa or more.

5. The powder pasting device according to claim 1, wherein
in the rubbing member, a surface that rubs the powder holding surface can house the powder

6. The powder pasting device according to claim 1, wherein
in the rubbing member, a surface that rubs the powder holding surface is constituted by a porous material or a brush.

7. The powder pasting device according to claim 5, wherein
the rubbing member includes a powder collecting member that collects the powder housed in the surface that rubs the powder holding surface.

8. The powder pasting device according to claim 1, wherein
the rubbing member is pressed with pressing force of 1 to 10 kPa against the powder holding surface and rubs the powder holding member.

9. The powder pasting device according to claim 1, wherein
the image pattern is formed of a material that is melted by heating and exhibits stickiness.

10. The powder pasting device according to claim 1, wherein
the image pattern is formed of a toner material.

11. The powder pasting device according to claim 9, further comprising
a heating member that heats an image pattern on one main surface of the recording medium sandwiched between the powder holding surface of the powder holding member and the facing member.

12. The powder pasting device according to claim 11, wherein
the facing member also serves as the heating member.

13. The powder pasting device according to claim 11, wherein
the powder holding member is formed of a heat resistant material.

14. The powder pasting device according to claim 1, wherein
the powder holding surface of the powder holding member is formed of silicon rubber.

15. The powder pasting device according to claim 1, wherein
the powder holding member rotates with a cylindrical side peripheral surface as the powder holding surface, and
the rubbing member rubs the powder holding surface by bringing a cylindrical side peripheral surface into contact with the powder holding surface, and is disposed on a downstream side of the powder supplying member in a rotation direction of the powder holding member.

16. The powder pasting device according to claim 1, wherein
the powder holding member rotates with a cylindrical side peripheral surface as the powder holding surface, and
the rubbing member rubs the powder holding surface by bringing a cylindrical side peripheral surface into contact with the powder holding surface, and also serves as the powder supplying member.

17. The powder pasting device according to claim 15, wherein
the rubbing member rotates in the same direction as the powder holding member.

18. The powder pasting device according to claim 1, further comprising
a powder collecting member that is disposed on one main surface of the recording medium and collects the powder from the one main surface of the recording medium in a state where the powder has been transferred onto the image pattern.

19. The powder pasting device according to claim 1, wherein
the powder is glossy.

20. An image forming apparatus comprising: the powder pasting device according to claim 1; and a pattern forming device that forms the image pattern on one main surface of the recording medium, wherein
the powder holding member of the powder pasting device is disposed on one main surface of the recording medium on which the image pattern is formed in the pattern forming device.

21. A powder pasting method for pasting powder on an image pattern formed on one main surface of a recording medium, the powder pasting method comprising:
supplying the powder to a powder holding surface of a powder holding member;
removing excess powder on the powder holding surface by rubbing the powder holding surface to which the powder has been supplied with a rubbing member, and sticking and holding the powder on the powder holding surface in a state where the powder is oriented; and
transferring the powder onto the image pattern by pressing the powder holding surface to which the powder is stuck and held against the image pattern formed on the one main surface of the recording medium and functioning as an adhesive.

22. An image forming method for pasting powder on an image pattern formed on one main surface of a recording medium, the image forming method comprising:
forming the image pattern functioning as an adhesive on the one main surface of the recording medium;
supplying the powder to a powder holding surface of a powder holding member;
removing excess powder on the powder holding surface by rubbing the powder holding surface to which the powder has been supplied with a rubbing member, and sticking and holding the powder on the powder holding surface in a state where the powder is oriented; and
transferring the powder onto the image pattern by pressing the powder holding surface on which the powder is stuck and held against the image pattern formed on the one main surface of the recording medium.
